(19) United States
(12) Patent Application Publication
(10) Pub. No.: US 2026/0037324 A1
(43) Pub. Date: Feb. 5, 2026

(54) DYNAMIC RESOURCE ALLOCATION IN STORAGE DEVICES

(71) Applicant: SK Hynix NAND Product Solutions Corp. (dba Solidigm), Rancho Cordova, CA (US)

(72) Inventors: Vinit VYAS, Folsom, CA (US); Hermes Alexandre ALCANTARA SILVA COSTA, Mission Viejo, CA (US); Vladimir ALVES, Newport Beach, CA (US); Jason MOLGAARD, Windsor, CO (US)

(21) Appl. No.: 18/794,533

(22) Filed: Aug. 5, 2024

(51) Int. Cl. G06F 9/50; G06F 13/20

(52) U.S. Cl. CPC G06F 9/5044; G06F 13/20

(57) ABSTRACT

This application is directed to resource management in a storage system that includes a non-volatile memory and a collection of resources having one or more processing cores. The storage system allocates a first subset of resources to process queues of I/O access operations requested by a host device. The first subset of resources includes a storage controller corresponding to a subset of processing cores. The storage system obtains a first request for adjusting resource allocation of the storage device, and the first request includes a target performance requirement for processing the queues of I/O access operations. The storage system determines that the target performance requirement can be satisfied by allocation of at least a target subset of resources. In response to the first request and based on the target subset of resources, a second subset of resources is allocated for processing the one or more queues of I/O access operations.

### TECHNICAL FIELD

This application relates generally to resource management in a storage device including, but not limited to, methods, systems, and non-transitory computer-readable media for allocating hardware resources of a storage device to facilitate memory access and data processing capabilities of the storage device.

### BACKGROUND

Memory is applied in a computer system to store instructions and data. The data are processed by one or more processors of the computer system according to the instructions stored in the memory. Multiple memory units are used in different portions of the computer system to serve different functions. Specifically, the computer system includes non-volatile memory that acts as secondary memory to keep data stored thereon if the computer system is decoupled from a power source. Examples of the secondary memory include, but are not limited to, hard disk drives (HDDs) and solid-state drives (SSDs). The secondary memory relies on a storage controller to manage its memory space and process read, write, and read-modify-write requests from a host device efficiently with low latency.

### SUMMARY

Various embodiments of this application are directed to methods, systems, devices, non-transitory computer-readable media for dynamically allocating resources (e.g., processing cores) between memory access functions and computational storage functions in a storage system or device (e.g., including one or more SSDs). The storage device includes a plurality of processing cores, and is transformed to a computational storage device (CSD) by activating a computational storage configuring two separate subsets of processing cores to a storage controller and a data processor, respectively. The data processor is configured to process internal computational storage operations (e.g., data processing operations) locally on the storage device, while the storage controller of the storage device specializes in performing generic storage functions including memory access functions (e.g., input/output (I/O) access operations) and internal memory management functions. In some embodiments, the storage device operates in a computational storage elevation (CSE) mode, when hardware resources (e.g., processing cores) are allocated or adjusted between the memory access functions and the computational storage functions.

More specifically, in some embodiments, a storage device (also called a computational storage device) receives a notification from a host device, and the notification includes a request for allocating a first subset of hardware resources. For example, the first subset of hardware resources includes a predefined throughput and/or a predefined memory access bandwidth corresponding to a number of I/O access operations. The predefined throughput and/or the predefined memory access bandwidth are applied to initialize the storage device during system bootup or to reset the storage device (e.g., using a get_features command). In some situations, the storage device includes a device firmware application configured to work with a device operation system of the storage device. The device firmware application may shift hardware resources from performing generic storage functionalities (e.g., host-related input/out access operations, device garbage collection, wear leveling) to performing computational storage tasks (e.g., data processing), ensuring that a host I/O throughput (e.g., I/O operations per second (IOPS)), a memory access bandwidth, and a quality of service (QoS) do not fail a target performance requirement set by the host device. Further, in some embodiments, the host device is allowed to send additional requests (e.g., an NVMe administrative command) to shift the hardware resources of the storage device to focus on the generic storage functionalities (e.g., host-related input/out access operations).

In one aspect, a method is implemented at a storage device having a non-volatile memory and a collection of resources. The collection of resources includes one or more processing cores. The method includes allocating a first subset of resources to process one or more queues of I/O access operations requested by a host device, and the first subset of resources includes a storage controller corresponding to a subset of the one or more processing cores. The method further includes obtaining a first request for adjusting resource allocation of the storage device, and the first request includes a target performance requirement for processing the one or more queues of I/O access operations. The method further includes determining that the target performance requirement for processing the one or more queues of I/O access operations can be satisfied by allocation of at least a target subset of resources, and in response to the first request and based on the target subset of resources, allocating a second subset of resources for processing the one or more queues of I/O access operations.

In some embodiments, the method further includes determining whether the storage device has the target subset of resources to be allocated to process the one or more queues of I/O access operations, generating an acknowledge message indicating whether the target performance requirement is satisfied based on a determination result, and in response to the first request, sending the acknowledge message to the host device.

In some embodiments, the method further includes, in accordance with a determination that the storage device does not have the target subset of resources to be allocated to process the one or more queues of I/O access operations, implementing one of: setting the second subset of resources to a default subset of resources, independently of the target performance requirement; and selecting the second subset of resources to maximize a performance level of the storage device for the one or more queues of I/O access operations.

In some embodiments, allocating the second subset of resources further includes, in accordance with a determination that the storage device has the target subset of resources to be allocated to process the one or more queues of I/O access operations, setting the second subset of resources to the target subset of resources.

In another aspect, some implementations include a storage system or a storage device (e.g., SSDs) having a non-volatile memory and a collection of resources, wherein the collection of resources includes one or more processing cores, and the non-volatile memory has instructions stored thereon for performing any of the above methods to allocate hardware resources for the storage system or the storage device.

In yet another aspect, some implementations include a non-transitory computer readable storage medium storing one or more programs. The one or more programs include instructions, which when executed by a storage system (e.g., SSDs) or a storage device (e.g., a SSD) cause the storage system or the storage device to implement any of the above methods to allocate hardware resources for the storage system or the storage device.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of an example system module in a typical electronic device in accordance with some embodiments.

FIG. 2 is a block diagram of a storage system of an example electronic device having one or more memory access queues, in accordance with some embodiments.

FIG. 3 is a block diagram of an example computer system that includes a storage system having an internal processing capability, in accordance with some embodiments.

FIG. 4 is a block diagram of an example computer system including a storage system that operates in compliance with a storage access and transport protocol, in accordance with some embodiments.

FIGS. 5A and 5B are schematic diagrams of two example resource allocation schemes of a storage system, in accordance with some embodiments.

FIG. 6 is a schematic diagram of a storage system in which hardware resources are arranged to a plurality of resource tiers, in accordance with some embodiments.

FIG. 7 is a flow diagram of a process of enabling hardware resource throttling in a storage system, in accordance with some embodiments.

FIG. 8 is a flow diagram of an example method for hardware resource allocation, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities.

In accordance with at least some embodiments of this application is a realization that, in a datacenter environment, there are scenarios during which a storage I/O access requirement from an underlying storage node (e.g., an SSD) may not stay high at all time. For example, a data interface coupling the storage device and the host device has a lower traffic at a downtime (e.g., after work hours), and the storage controller does not need to implement as many I/O access operations at the downtime as it does during the work hours. In some embodiments, part of the storage controller is re-configured to implement the computational storage functions as a data process, while allowing the storage device to maintain a sufficient bandwidth or throughput for I/O access operations needed by the host device.

Further, in accordance with at least some embodiments of this application is a realization that computational storage devices (e.g., storage devices configured to implement data processing) have been around for some time and that their use has been tested for background data processing, offloading compute functions from the host device. In accordance with at least some embodiments of this application is a realization that background data processing competes with device resources dedicated to the generic storage functions and could reduce overall performance of data transfer. In various embodiments of this application, a host device sets a target performance requirement providing information regarding reduced or increased I/O access operations, and resources for offloading computation of a storage device are adjusted adaptively without the IO access operations.

Various embodiments of this application are directed to methods, systems, devices, non-transitory computer-readable media for dynamically allocating resources (e.g., processing cores) between memory access functions and computational storage functions in a storage system or device (e.g., including one or more SSDs). In some embodiments, a storage device (also called a computational storage device) receives, from a host device, a request for allocating a first subset of hardware resources. For example, the first subset of hardware resources includes a predefined throughput or bandwidth corresponding to a number of I/O access operations. The predefined throughput or bandwidth is applied to initialize the storage device during system bootup or to reset the storage device. In some situations, the storage device may shift hardware resources from performing generic storage functionalities (e.g., host-related input/out access operations, device garbage collection, wear leveling) to performing computational storage tasks (e.g., data processing), ensuring that a host I/O throughput, a memory access bandwidth, and/or a QoS do not fail a target performance requirement set by the host device. Further, in some embodiments, the host device issues additional requests to shift the hardware resources of the storage device to focus on the generic storage functionalities (e.g., host-related input/out access operations).

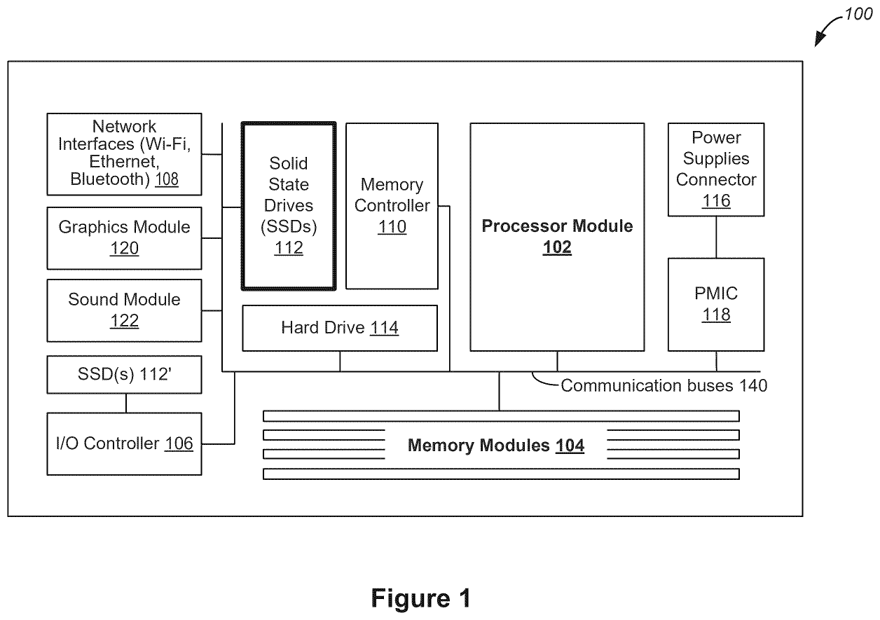

FIG. 1 is a block diagram of an example system module 100 in a typical electronic system in accordance with some embodiments. The system module 100 in this electronic system includes at least a processor module 102, memory modules 104 for storing programs, instructions and data, an input/output (I/O) controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse or a trackpad) via a universal serial bus interface. In some embodiments, the network interfaces 108 includes one or more interfaces for Wi-Fi, Ethernet and Bluetooth networks, each allowing the electronic system to exchange data with an external source, e.g., a server or another electronic system. In some embodiments, the communication buses 140 include circuitry (sometimes called a chipset) that interconnects and controls communications among various system components included in system module 100.

In some embodiments, the memory modules 104 include high-speed random-access memory, such as static random-access memory (SRAM), double data rate (DDR) dynamic random-access memory (DRAM), or other random-access solid state memory devices. In some embodiments, the memory modules 104 include non-volatile memory, such as one or more magnetic disk storage devices, optical disk storage devices, flash storage devices, or other non-volatile solid state storage devices. In some embodiments, the memory modules 104, or alternatively the non-volatile storage device(s) within the memory modules 104, include a non-transitory computer readable storage medium. In some embodiments, memory slots are reserved on the system module 100 for receiving the memory modules 104. Once inserted into the memory slots, the memory modules 104 are integrated into the system module 100.

In some embodiments, the system module 100 further includes one or more components selected from a storage controller 110, SSD(s) 112, an HDD 114, power management integrated circuit (PMIC) 118, a graphics module 120, and a sound module 122. The storage controller 110 is configured to control communication between the processor module 102 and memory components, including the memory modules 104, in the electronic system. The SSD(s) 112 are configured to apply integrated circuit assemblies to store data in the electronic system, and in many embodiments, are based on NAND or NOR memory configurations. The HDD 114 is a conventional data storage device used for storing and retrieving digital information based on electromechanical magnetic disks. The power supply connector 116 is electrically coupled to receive an external power supply. The PMIC 118 is configured to modulate the received external power supply to other desired DC voltage levels, e.g., 5V, 3.3V or 1.8V, as required by various components or circuits (e.g., the processor module 102) within the electronic system. The graphics module 120 is configured to generate a feed of output images to one or more display devices according to their desirable image/video formats. The sound module 122 is configured to facilitate the input and output of audio signals to and from the electronic system under control of computer programs.

Alternatively or additionally, in some embodiments, the system module 100 further includes SSD(s) 112′ coupled to the I/O controller 106 directly. Conversely, the SSDs 112 are coupled to the communication buses 140. In an example, the communication buses 140 operates in compliance with Peripheral Component Interconnect Express (PCIe or PCI-E), which is a serial expansion bus standard for interconnecting the processor module 102 to, and controlling, one or more peripheral devices and various system components including components 110-122.

Further, one skilled in the art knows that other non-transitory computer readable storage media can be used, as new data storage technologies are developed for storing information in the non-transitory computer readable storage media in the memory modules 104, SSD(s) 112 or 112′, and HDD 114. These new non-transitory computer readable storage media include, but are not limited to, those manufactured from biological materials, nanowires, carbon nanotubes and individual molecules, even though the respective data storage technologies are currently under development and yet to be commercialized.

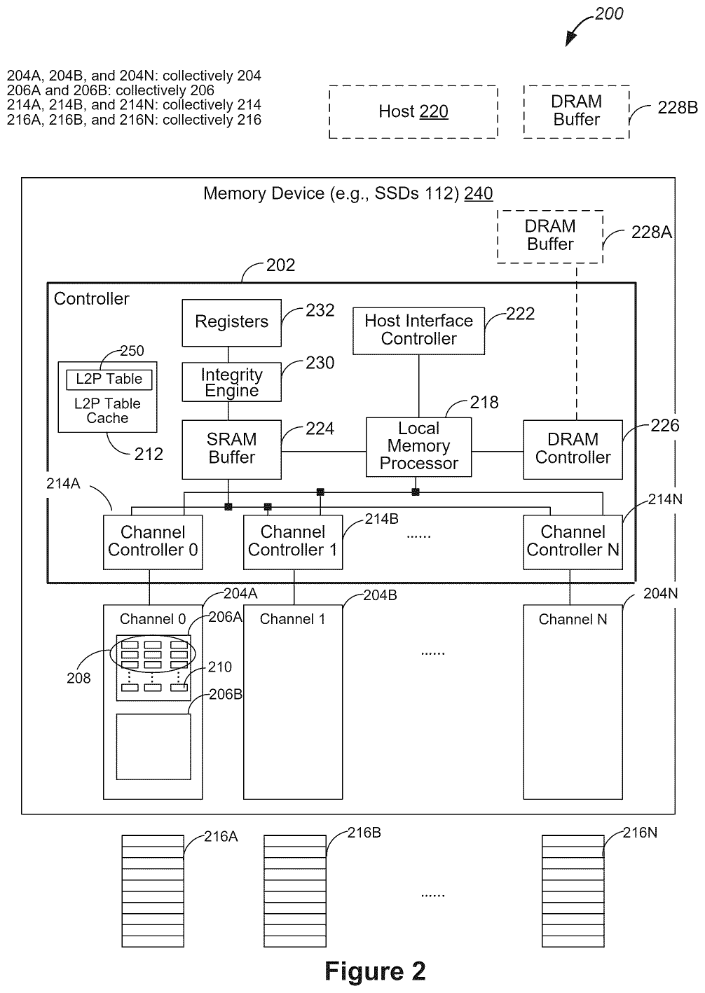

FIG. 2 is a block diagram of a storage system 200 of an example electronic device having one or more memory access queues, in accordance with some embodiments. The storage system 200 is coupled to a host device 220 (e.g., a processor module 102 in FIG. 1) and configured to store instructions and data for an extended time, e.g., when the electronic device sleeps, hibernates, or is shut down. The host device 220 is configured to access the instructions and data stored in the storage system 200 and process the instructions and data to run an operating system (OS) and execute user applications. The storage system 200 includes one or more storage devices 240 (e.g., SSD(s)). Each storage device 240 further includes a controller 202 and a plurality of memory channels 204 (e.g., channel 204A, 204B, and 204N). Each memory channel 204 includes a plurality of memory cells. The controller 202 is configured to execute firmware level software to bridge the plurality of memory channels 204 to the host device 220. In some embodiments, each storage device 240 is formed on a printed circuit board (PCB).

Each memory channel 204 includes on one or more memory packages 206 (e.g., two memory dies). In an example, each memory package 206 (e.g., memory package 206A or 206B) corresponds to a memory dic. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the storage device 240 includes a plurality of superblocks. Each superblock includes a plurality of memory blocks each of which further includes a plurality of memory pages 210. For each superblock, the plurality of memory blocks are configured to be written into and read from the storage system via a memory input/output (I/O) interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, where each memory block is distributed on a distinct one of the plurality of memory dies 206 includes a plurality of pages, has the same die, plane, and block designations, and is accessed via a distinct channel of the distinct memory die 206. The storage device 240 stores information of an ordered list of superblocks in a cache of the storage device 240. In some embodiments, the cache is managed by a host driver of the host device 220, and called a host managed cache (HMC).

In some embodiments, the storage device 240 includes a single-level cell (SLC) NAND flash memory chip, and each memory cell stores a single data bit. In some embodiments, the storage device 240 includes a multi-level cell (MLC) NAND flash memory chip, and each memory cell of the MLC NAND flash memory chip stores 2 data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits. Compared with the non-SLC NAND flash memory chips (e.g., MLC SSD, TLC SSD, QLC SSD, PLC SSD), the SSD that has SLC NAND flash memory chips operates with a higher speed, a higher reliability, and a longer lifespan, and however, has a lower device density and a higher price.

Each memory channel 204 is coupled to a respective channel controller 214 (e.g., controller 214A, 214B, or 214N) configured to control internal and external requests to access memory cells in the respective memory channel 204. In some embodiments, each memory package 206 (e.g., each memory die) corresponds to a respective queue 216 (e.g., queue 216A, 216B, or 216N) of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the storage device 240 corresponds to a single queue 216 of memory access requests. Each memory access request is optionally received internally from the storage device 240 to manage the respective memory channel 204 or externally from the host device 220 to write or read data stored in the respective channel 204. Specifically, each memory access request includes one of: a system write request that is received from the storage device 240 to write to the respective memory channel 204, a system read request that is received from the storage device 240 to read from the respective memory channel 204, a host write request that originates from the host device 220 to write to the respective memory channel 204, and a host read request that is received from the host device 220 to read from the respective memory channel 204. It is noted that system read requests (also called background read requests or non-host read requests) and system write requests are dispatched by a storage controller 202 to implement internal memory management functions including, but are not limited to, garbage collection, wear levelling, read disturb mitigation, memory snapshot capturing, memory mirroring, caching, and memory sparing. In some embodiments, each of a host write request and a host read request corresponds to a respective input/output (I/O) access operation. Alternatively, in some embodiments, each of a system read request, a system write request, a host write request, and a host read request corresponds to a respective input/output (I/O) access operation

In some embodiments, in addition to the channel controllers 214, the controller 202 further includes a local memory processor 218, a host interface controller 222, an SRAM buffer 224, and a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks are written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the controller 202. Alternatively, in some embodiments, the local memory processor 218 stores data to be written into, or read from, each memory block in the plurality of memory channels 204 in a DRAM buffer 228A that is included in storage device 240, e.g., by way of the DRAM controller 226. Alternatively, in some embodiments, the local memory processor 218 stores data to be written into, or read from, each memory block in the plurality of memory channels 204 in a DRAM buffer 228B that is main memory used by the processor module 102 (FIG. 1). The local memory processor 218 of the controller 202 accesses the DRAM buffer 228B via the host interface controller 222.

In some embodiments, data in the plurality of memory channels 204 is grouped into coding blocks, and each coding block is called a codeword. For example, each codeword includes n bits among which k bits correspond to user data and (n-k) corresponds to integrity data of the user data, where k and n are positive integers. In some embodiments, the storage device 240 includes an integrity engine 230 (e.g., an LDPC engine) and registers 232, which include a plurality of registers or SRAM cells or flip-flops and are coupled to the integrity engine 230. The integrity engine 230 is coupled to the memory channels 204 via the channel controllers 214 and SRAM buffer 224. Specifically, in some embodiments, the integrity engine 230 has data path connections to the SRAM buffer 224, which is further connected to the channel controllers 214 via data paths that are controlled by the local memory processor 218. The integrity engine 230 is configured to verify data integrity and correct bit errors for each coding block of the memory channels 204.

In some embodiments, the storage system 200 includes an SSD having an L2P address indirection table 250 that stores physical addresses for a set of logical addresses, e.g., a logical block address (LBA). In some embodiments, the L2P address indirection table 250 is stored in an L2P table cache 212 included in the controller 202. Alternatively, in some embodiments, the storage system 200 includes a DRAM buffer 228A, and the L2P address indirection table 250 is stored in the DRAM buffer 228A. The local memory processor 218 of the controller 202 accesses the DRAM buffer 228A via a DRAM controller 226.

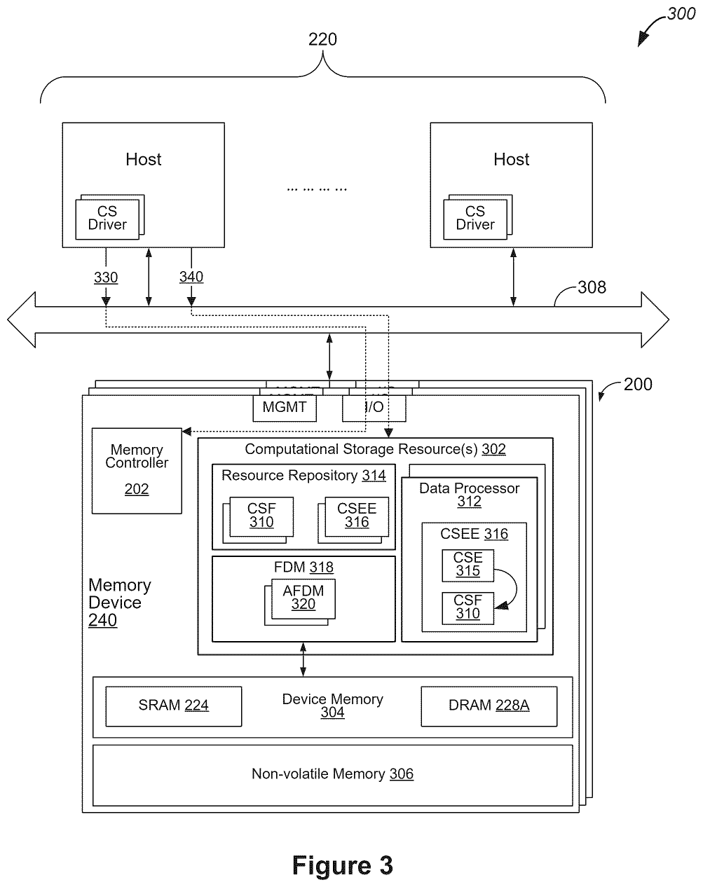

FIG. 3 is a block diagram of an example computer system 300 that includes a storage system 200 having an internal processing capability, in accordance with some embodiments. The storage system 200 is also called a computational storage device (CSD), and includes one or more storage devices 240 (e.g., SSDs). Each storage device 240 further includes a storage controller 202, a device memory 304, and a non-volatile memory 306 (e.g., memory channels 204). The host device(s) 220 and the one or more storage devices 240 of the storage system 200 are coupled to each other via a communication fabric 308. The communication fabric 308 includes a communication bus 140 (FIG. 1) that operates in compliance with a data bus standard, e.g., Peripheral Component Interconnect Express (PCIe), Ethernet standards. The host device(s) 220 are configured to issue memory access requests to write data into, and read data from, the non-volatile memory 306. The storage controller 202 accesses the non-volatile memory 306 in response to the memory access operations. Additionally, in some embodiments, the storage controller 202 dispatch system read requests (also called background read requests or non-host read requests) and system write requests to implement internal memory management functions including, but are not limited to, garbage collection, wear levelling, read disturb mitigation, memory snapshot capturing, memory mirroring, caching, and memory sparing. The device memory 304 of each storage device 240 further includes one or more of a L2P table cache 212, a SRAM buffer 224, and a DRAM buffer 228A, and is configured to store data temporarily while the storage controller 202 accesses the non-volatile memory 306 for memory accesses or internal memory management.

In some embodiments, the storage controller 202 is dedicated to processing the memory access requests and internal memory management functions. A storage device 240 further includes one or more computational storage resources (CSRs) 302 configured to implement data processing operations locally on the storage device 240. A set of predefined data processing operations are implemented to perform a computational storage function (CSF) 310, which is distinct from the memory access and internal memory management functions performed by the storage controller 202. In some embodiments, a computational storage resource 302 processes user data that are received from the host device(s) 220 or extracted from the non-volatile memory 306 during the data processing operations. In some embodiments, the processed data are stored into the non-volatile memory 306 or sent to the host device(s) 220 via the fabric 308. Further, in some embodiments, a subset of the user data, the process data, and intermediate data generated during the data processing operations is temporarily stored in the device memory 304 (e.g., SRAM buffer 224, DRAM buffer 228A).

In some embodiments, the computational storage resource 302 includes one or more data processors 312 and a resource repository 314. The one or more data processors 312 provide a computational storage engine configured to perform one or more predefined data processing operations, e.g., associated with a computational storage function 310 of the computational storage resource 302. In some embodiments, the computational storage function 310 corresponds to an in-memory application associated with the computational storage engine, and is implemented via the computational storage engine in the storage device 240. The resource repository 314 is a centralized location (e.g., memory space) storing various types of data and resources, such as software libraries, configuration files, media files, or any other type of data needed for a plurality of computational storage functions 310 performed by the computational storage resource 302. For example, the resource repository 314 stores instructions for creating a computational storage engine environment (CSEE) 316 and instructions for implementing a set of data processing operations associated with a computational storage function 310 in the CSEE 316. Instructions are loaded from the resource repository 314 and executed by the data processor 312, thereby creating the CSEE 316 where the computational storage engine 315 is executed to implement data processing operations associated with the computational storage function 310.

In some embodiments, the computational storage resource 302 further includes a function data memory (FDM) 318 for storing data that are used or generated by the computational storage engine 315 for performing a computational storage function 310. In some embodiments, the function data memory 318 is included in the device memory 304. For example, the function data memory 318 corresponds to a portion of the DRAM buffer 228A (FIG. 2). In another example, the function data memory 318 corresponds to a portion of the SRAM buffer 224 (FIG. 2). Further, in some embodiments, a portion of the function data memory 318 (also called an allocated FDM (AFDM) 320) is allocated for one or more instances of a computational storage function 310.

In some embodiments, a host device 22 issues a memory read or write request 330 to a storage device 240 of the storage system 200, and the storage controller 202 of the storage device 240 receives the memory read or write request 330 and accesses the non-volatile memory 306 accordingly. Alternatively, in some embodiments, a host device 22 issues a data processing request 340 to the storage device 240, and a data processor 312 of the computational storage resource 302 (e.g., the computational storage engine 315) receives the data processing request 340 and processes user data extracted from the data processing request or the non-volatile memory 306.

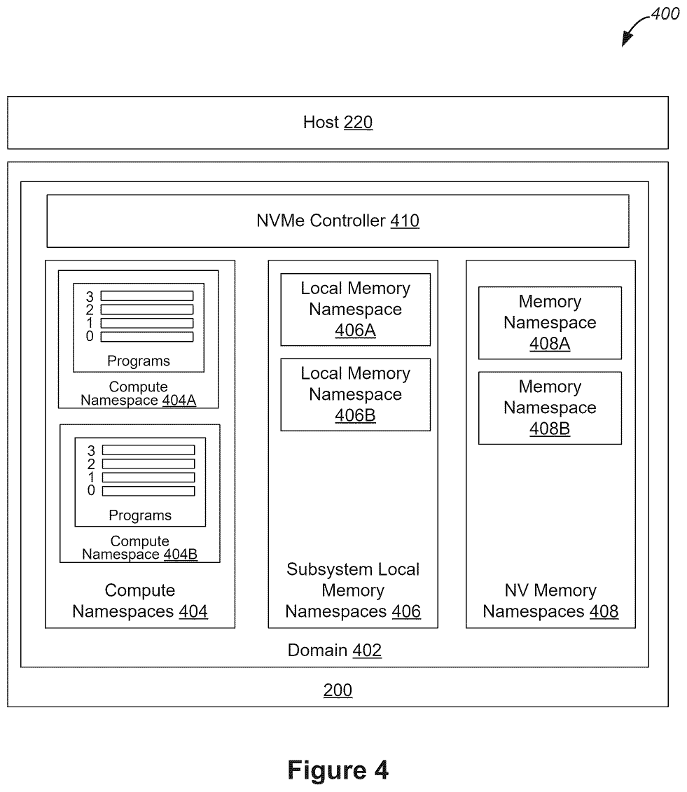

FIG. 4 is a block diagram of an example computer system 400 including a storage system 200 that operates in compliance with a storage access and transport protocol (e.g., nonvolatile memory express (NVMe)), in accordance with some embodiments. The storage system 200 includes one or more storage devices 240 each of which corresponds to a domain 402 according to the storage access and transport protocol. Each domain 402 corresponding to a respective storage device 240 includes a one or more compute namespace 404, local memory namespaces 406, memory namespaces 408, and a domain controller 410. Each namespace is a collection of LBAs accessible to, or associated with, a respective one of the plurality of programs.

A storage device 240 includes one or more processors having a computation capability (e.g., a storage controller 202, a data processor 312), a device memory 304 (e.g., a cache 212, a SRAM buffer 224, a DRAM buffer 228A), and a non-volatile memory 306. When the storage device 240 executes a plurality of programs, resources of the storage controller 202, the device memory 304, and the non-volatile memory 306 are allocated to implement the plurality of programs based on the storage access and transport protocol (e.g., NVMe). A plurality of compute namespaces 404 (e.g., 404A and 404B) correspond to, are configured to provide, instructions of the plurality of programs executed by the one or more programs of the storage device 240. Resources of the device memory 304 are allocated based on a plurality of local memory namespaces 406 (e.g., 406A and 406B) to facilitate execution of the plurality of programs by the storage device 240, so are resources of the non-volatile memory 306 allocated based on a plurality of memory namespaces 408 (e.g., 408A and 408B). It is noted that, in some embodiments, a number of programs is not limited to 2 and may be greater than 2, thereby creating more than two namespaces in each type of compute namespaces 404, 406, or 408.

In an example, a compute namespace 404A corresponds to a respective local memory namespace 406A and a respective non-volatile memory namespace 408A. The compute namespace 404A provides instructions of a corresponding program for execution by the one or more processors of the storage device 240. In some situations, input data that are processed, and output data that are generated, by these instructions are temporarily stored based on the local memory namespace 406A. In some situations, the input data are extracted based on the non-volatile memory namespace 408A, and the output data are stored based on the non-volatile memory namespace 408A. By these means, namespace allocation and utilization in the domain 402 corresponding to the storage device 240 are managed according to the storage access and transport protocol.

In some embodiments, the storage access and transport protocol includes a NVMe protocol for accessing flash storage (e.g., SSDs) via a PCI Express (PCIe) bus. The PCIe bus is configured to support a plurality of parallel command queues (e.g., on an order of 104 queues), thereby operating with a substantially high throughput and a substantially fast response time. In some embodiments, the host device 220 is configured to communicate and interact with each storage device 240 (e.g., SSD) as a standard NVMe storage device using the NVMe protocol. The host device 220 is configured to read and write data and implement data processing operations on the storage device 240 using NVMe commands.

In some embodiments, the host device 220 uses an operating system (e.g., a Linux operating system), and the CSRs 302 (FIG. 3) of the storage device 240 uses an embedded operating system (e.g., an embedded Linux operating system) that matches the operating system of the host device 220. In some embodiments, the host device 220 uses extended vendor unique commands to control and interact with the embedded operating system of the CSRs 302 of the storage device 240.

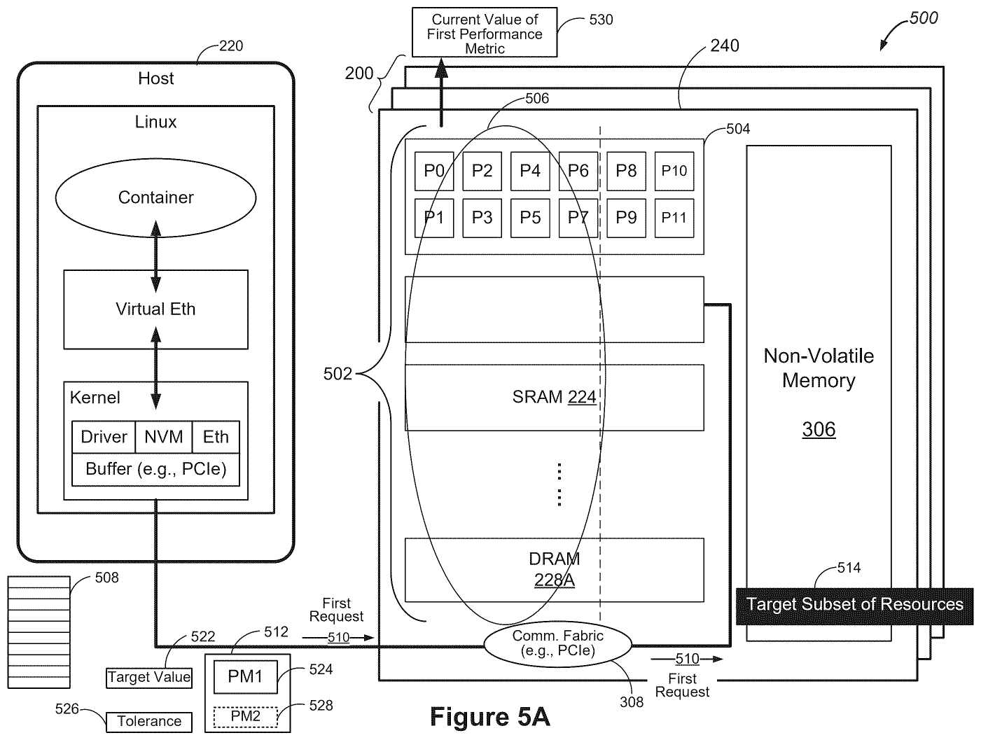

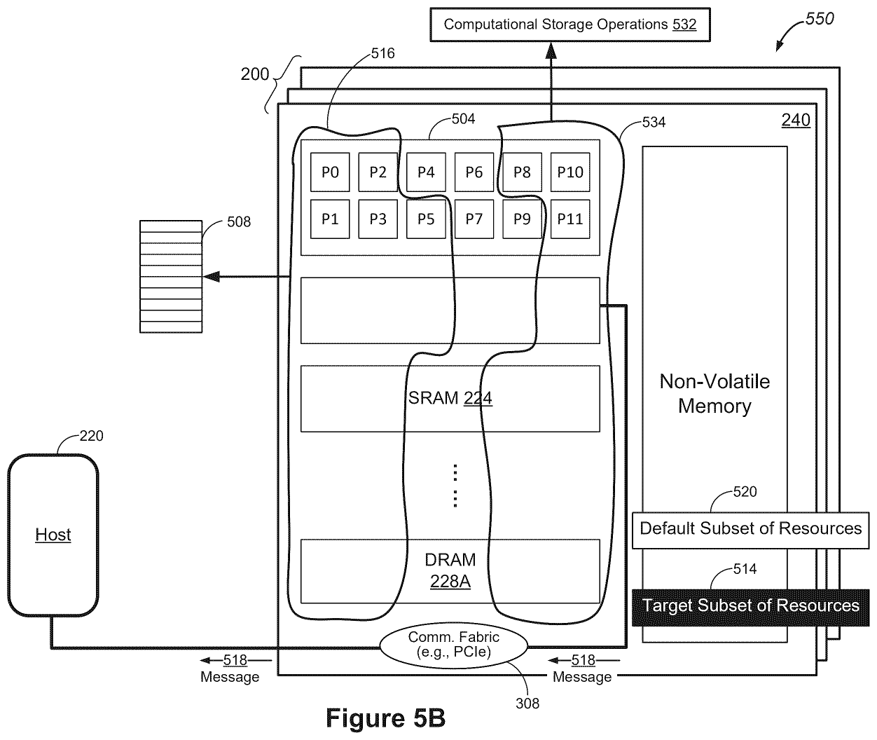

FIGS. 5A and 5B are schematic diagrams of two example resource allocation schemes 500 and 550 of a storage system 200, in accordance with some embodiments. The storage system 200 includes one or more storage devices 240, and is coupled to a host device 220. A storage device 240 has a non-volatile memory 306 (e.g., a plurality of memory channels 204 having a plurality of pages 210) and a collection of resources 502. The collection of resources 502 includes at least one or more processing cores 504 (e.g., P0-P11). In accordance with the resource allocation schemes 500, a first subset of resources 506 is allocated to process one or more queues 508 of input/output (I/O) access operations requested by the host device 220. The first subset of resources 506 includes a storage controller 202 (FIG. 2) corresponding to a subset of the one or more processing cores 504 (e.g., P0-P5). Stated another way, the first subset of resources 506 including the subset of the processing cores 504 (e.g., P0-P5) is allocated to process the queue(s) 508 of I/O access operations, and configured to act as the storage controller 202 of the storage device 240.

The storage device 240 obtains a first request 510 for adjusting resource allocation of the storage device 240. In some embodiments, the storage device 240 receives the first request 510 from the host device 220 coupled to the storage device 240.

Alternatively, in some embodiments, the storage device 240 generates the first request 510 locally. The first request 510 includes a target performance requirement 512 for processing the one or more queues 508 of I/O access operations. The storage device 240 determines that the target performance requirement 512 for processing the one or more queues 508 of I/O access operations can be satisfied by allocation of at least a target subset of resources 514. In response to the first request 510 and based on the target subset of resources 514, a second subset of resources 516 is allocated for processing the one or more queues 508 of I/O access operations. Additionally, in some embodiments, the storage device 240 disables allocation of the first subset of resources, independently of the target subset of resources, before allocating the second subset of resources 516 for processing the one or more queues 508 of I/O access operations.

The one or more queues 508 of I/O access operations are managed by the host device 220. Each of the one or more queues 508 of I/O access operations may include a subset of: host-request memory read, host-requested memory write, garbage collection, wear levelling, read disturb mitigation, memory snapshot capturing, memory mirroring, caching, and memory sparing. I/O access operations may be added to the queues 508 dynamically, while earlier I/O access operations are implemented and removed from the queue(s) 508.

In some embodiments, the storage device 240 (e.g., the storage controller 202 formed by a subset of processing cores 504) determines whether the storage device 240 has the target subset of resources 514 to be allocated to process the one or more queues 508 of I/O access operations. An acknowledge message 518 is generated indicating whether the target performance requirement 512 is satisfied based on a determination result. In response to the first request 510, the storage device 240 sends the acknowledge message 518 to the host device 220. More specifically, in some embodiments, in accordance with a determination that the storage device 240 has the target subset of resources 514 to be allocated to process the one or more queues 508 of I/O access operations, the second subset of resources 516 is set to match the target subset of resources 514. The acknowledge message 518 may indicate that the target performance requirement 512 is satisfied.

Conversely, in some embodiments, in accordance with a determination that the storage device 240 does not have the target subset of resources 514 to be allocated to process the one or more queues 508 of I/O access operations, the storage device 240 sets the second subset of resources 516 to a default subset of resources 520, independently of the target performance requirement 512. The storage device 240 may further send the acknowledge message 518 indicating to the host device 220 that it fails to satisfy the target performance requirement 512 or allocates the default subset of resources 520. In an example, the default subset of resources 520 is none. Stated another way, if the storage device 240 does not have the target subset of resources 514, it may choose not to allocate any resources to process the one or more queues 508 of I/O access operations, and instead, send the acknowledge message 518 indicating to the host device 220 that it fails to allocate the target subset of resources 514 or satisfy the target performance requirement 512.

Conversely and alternatively, in some embodiments, in accordance with a determination that the storage device 240 does not have the target subset of resources 514 to be allocated to process the one or more queues 508 of I/O access operations, the storage device 240 selects the second subset of resources 516 to maximize a performance level of the storage device 240 for the one or more queues 508 of I/O access operations. The storage device 240 may further send the acknowledge message 518 indicating to the host device 220 that it fails to satisfy the target performance requirement 512 or allocates the second subset of resources 520.

In some embodiments, the target performance requirement 512 further includes a target value 522 of a first performance metric 524, and a target tolerance 526 of a second performance metric 528. The target subset of resources is determined based on the target value 522 of the first performance metric 524 and the target tolerance 526 of the second performance metric 528. The storage device allocates the second subset of resources 516 by identifying one or more predefined resource combinations corresponding to a plurality of resource tiers to the storage device 240, and determines that one of the one or more predefined resource combinations corresponding to the second subset of resources 516 results in the first performance metric 524 meeting the target value 522 and the second performance metric 528 staying within the target tolerance 526, thereby reserving the second subset of resources 516. Each predefined resource combination includes a subset of one or more processing cores 504 (e.g., P0-P7 and P9), a subset of DRAM buffer 228A, a subset of SRAM buffer 224 (FIG. 2), a subset of OS instances, a subset of affinity to cores, or a combination thereof. Every two predefined resource combinations are different from one another in a size of at least one of the subset of one or more processing cores 504, the subset of DRAM buffer 228A, the subset of SRAM buffer 224, the subset of OS instances, and the subset of affinity to cores.

Further, in some embodiments, the first performance metric 524 includes a memory access bandwidth corresponding to a rate at which data are read from, or stored into, the non-volatile memory 306 by the one or more queues 508 of I/O access operations in response to host requests (e.g., request 510) of the host device 220. The second performance metric 528 includes a memory throughput representing a number of input/output operations per second (IOPS) corresponding to the one or more queues 508 of I/O access operations implemented by the storage controller 202 in response to the host requests. Converse, in some embodiments, the first performance metric 524 includes a memory throughput representing a number of input/output operations per second (IOPS) corresponding to the one or more queues 508 of I/O access operations implemented by the storage controller 202 in response to the host requests. The second performance metric 528 includes a memory access bandwidth corresponding to a rate at which data are read from, or stored into, the non-volatile memory 306 by the one or more queues 508 of I/O access operations in response to host requests (e.g., request 510) of the host device 220.

In some situations, the host device 220 expects a lower I/O activity level (e.g., corresponding to less I/O access operations at a downtime), and sends an NVMe admin command to the storage device 240 having a computational storage elevation (CSE) mode. In the CSE mode, hardware resources (e.g., processing cores) are re-distributed between the memory access functions and the computational storage functions to allocate more resources to implement the computational storage functions internally in the storage device 240. The NVMe admin command includes parameters associated with the CSE mode, and the storage device 240 is expected to function based on the parameters in the CSE mode. In an example, the NVMe admi command includes a plurality of performance metrics that are organized in a command structure shown in Table 1.

TABLE 1
Command Parameters used in a Command Setting
a Target Performance Requirement for Resource
Allocation in a CSE Mode of a Storage Device

| Order in | | |
|---|---|---|
| NVMe | | |
| Admin | | |
| Command | Description of Parameters | Example |
| (1) | A first performance metric having a target | I/O |
| | value that the host device 220 expects the | Access |
| | storage device 240 to provide. | Bandwidth |
| (2) | The target value that the host device 220 | 50% |
| | expects the storage device 240 to provide, | |
| | where in some embodiments, the target value | |
| | is distinct from, represented in a percentage | |
| | of, a default value enabled at system bootup. | |
| (3) | A second performance metric having a target | Through- |
| | tolerance that the host device 220 allows | put |
| | the storage device 240 to compromise. | |
| (4) | The target tolerance to which the storage | +/−5% |
| | device allows the storage device to compromise, | |
| | where in some embodiments, the target threshold | |
| | is represented in percentage with reference to | |
| | the target value of the first performance metric. | |
| (5) | Repeat (3) and (4) for each of a set of one or | |
| | more additional performance metrics (e.g., which | |
| | is adjustable and can be retrieved using a | |
| | get_features command) | |

In some embodiments associated with Table 1, the first subset of resources 506 may be associated with a default performance requirement that is applied at system booting or reset to prioritize the one or more queues 508 of I/O access operations for the host device 220. The first request 510 includes the target performance requirement 512 that reduces the default performance requirement for a downtime. Stated another way, in an example, the target performance requirement 512 includes a target value of a first performance metric 524 (e.g., bandwidth). The first subset of resources 506 corresponds to a current value 530 of the first performance metric, e.g., corresponding to the default performance requirement, and the target value 522 is lower than the current value 530 (e.g., equal to 50% of the current value 530). Further, in some embodiments, the host device 220 may issue a recovery request after the first request 510 to terminate the target performance requirement 512 and recover the default performance requirement. Alternatively, in some embodiments, the host device may issues a second request after the first request 510, and the second request include another performance requirement distinct from the target performance requirement 512 or the default performance requirement.

Referring to Table 1, in some embodiments, the target performance requirement 512 includes more than two performance metrics. In some embodiments, the storage device 240 allocates the first subset of resources 506 during a system bootup stage by varying a size of the storage controller 202 to prioritize a first set of performance metrics over a second set of performance metrics and adjust each of the first set of performance metrics into a respective metric range. Subsequently, the first subset of resources 506 of the storage device is adjusted (e.g., to the second subset of resources 516) based on a subset of the plurality of performance metrics, and the target performance requirement 512 includes at least one of the plurality of performance metrics. In some embodiments, each of the plurality of performance metrics is one of: a memory throughput, a memory access bandwidth, and a QoS, and is greater than a respective metric threshold when the second subset of resources 516 is applied to implement the one or more queues 508 of I/O access operations, thereby ensuring that a certain performance level is maintained for performing the I/O access operations in the queue(s) 508 for the host device 220.

In some embodiments, the CSE mode is enabled when a device firmware application communicates with a device operating system and other low level embedded software applications. Hardware resources that are running the device firmware applications can be dynamically adjusted to execute computational storage functions. For example, if the device firmware application is executed on a multicore symmetric multi-processing (SMP) architecture, one or more of the processing cores 504 are switched from implementing I/O access operations and made, through an OS abstraction, execute computational storage tasks exclusively in runtime. Further, in some embodiments, after the storage device 240 has been modified in its operations to work in the CSE mode, it sends the acknowledge message 518 (e.g., indicating that this event has a “SUCCESS” status) upstream to the host device 220. In some situations, the acknowledge message 518 includes an NVMe command.

In some embodiments, the storage device 240 operates in the CSE mode, allocating general purpose hardware resources (e.g., processing cores 504, SRAM buffer 224, DRAM buffer 228A) for implementing computational storage functions. In some situations, the storage device 240 expects normal I/O traffic from an upstream host device 220, and operates with its default performance metric capacity. Subsequently, the storage device 240 sends a command to the host device 220 to indicate that the storage device 240 needs more hardware resources to operate in the CSE mode or that the storage device 240 can terminate the CSE mode to release the hardware resources. When allocated with the resources for the CSE mode, the storage device 240 responds to the host device 220 with the acknowledge message 518 (e.g., an NVMe command) indicating a “SUCCESS” status. Conversely, when the resources is not available for the CSE mode, the storage device 240 responds to the host device 220 with the acknowledge message 518 (e.g., an NVMe command) indicating an “ERROR” status.

In some embodiments, after the second subset of resources 516 is allocated to implement the one or more queues 508 of I/O access operations for the host device 220, the storage device 240 may assign all of remaining resources to implement its computational storage operations. In some embodiments, after the second subset of resources 516 is allocated, the storage device 240 may assign a subset (less than all) of remaining resources to implement its computational storage operations. Based on the second subset of resources 516, the storage device allocates a third subset of resources 534 (e.g., all or less than all of the remaining resources) to implement a plurality of computational storage operations 532 distinct from the one or more queues 508 of I/O access operations. In some embodiments, the third subset of resources 534 is allocated in accordance with a determination that a CSE mode is activated in the storage device

In some embodiments, the first request 510 is received according to a schedule including a host downtime period and a host busy period. The third subset of resources 534 includes a third number (N3) of processing cores 504. Whiling allocating the first subset of resources 506 to the one or more queues 508 of I/O access operations, the storage device 240 allocates a fourth number (N4) of processing cores 504 to implement the plurality of computational storage operations. The third number (N3) is greater than the fourth number (N4) during the host downtime period, and the third number (N3) is less than the fourth number (N4) during the host busy period. Further, in some embodiments, the first subset of resources 506 (FIG. 5A) includes a first number (N1, e.g., equal to 8) of processing cores 504, and the second subset of resources 516 (FIG. 5B) includes a second number (N2, e.g., equal to 5) of processing cores 504. In an example, the first number (N1) of processing cores 504 (e.g., P0-P7 in FIG. 5A) and the fourth number (N4) of processing cores 504 (e.g., P8-P11 in FIG. 5A) are complementary to each other in the one or more processing cores 504. In an example not shown, the second number (N2) of processing cores 504 (e.g., P0-P3 and P5 in FIG. 5B) and the third number (N3) of processing cores 504 (e.g., P4 and P6-P11, not grouped in FIG. 5B) are complementary to each other in the one or more processing cores 504.

In some embodiments, the third subset of resources 534 (FIG. 5B) includes a subset of the one or more processing cores 504 that are unused before the first request 510 was obtained, and the first request 510 includes a request for a burst of workloads including the plurality of computational storage operations. In some embodiments, each of the plurality of computational storage operations includes a data processing operation performed internally in the storage device 240 to process data stored or to be stored in the non-volatile memory 306. In some embodiments not shown, the first subset of resources 506 includes a first processing core (e.g., P0) configured to execute a device I/O task, and the storage device 240 allocates the third subset of resources 534 by reassigning, on an operating system abstraction level, the first processing core to execute a subset of the plurality of computational storage operations.

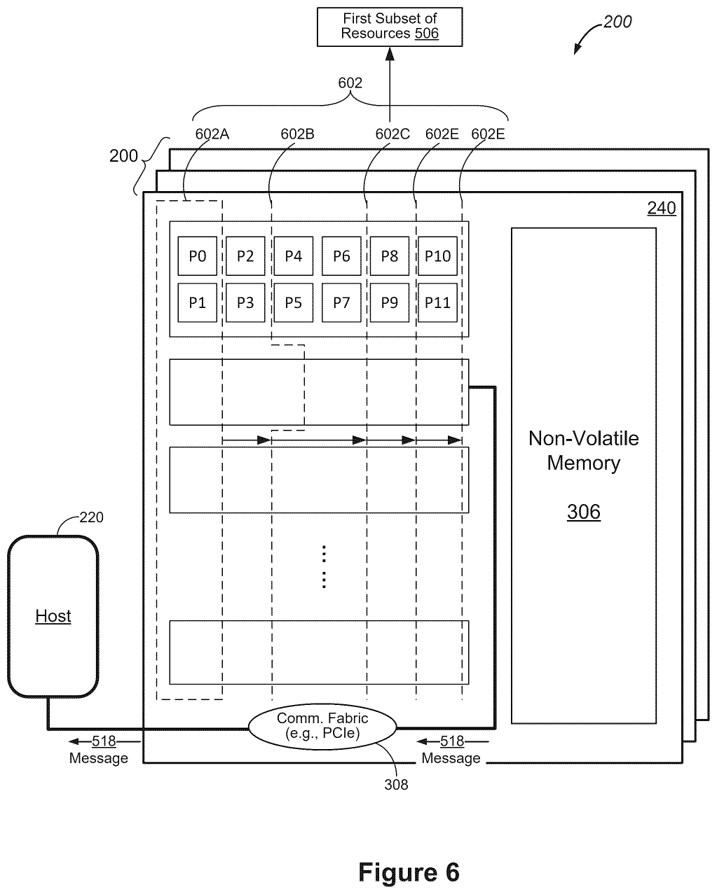

FIG. 6 is a schematic diagram of a storage system 200 in which hardware resources are arranged to a plurality of resource tiers 602 (e.g., 602A-602E), in accordance with some embodiments. In some embodiments, the first subset of resources 506 (FIG. 5A) is allocated during a system bootup stage. During the system bootup stage, the storage device 240 provides, to a host device 220, information of a plurality of resource tiers 602. The storage device 240 receives a selection of an initial resource tier from the plurality of resource tiers 602A. The first subset of resources 506 (FIG. 5A) is allocated based on the selection of the initial resource tier. In an example, the plurality of resource tiers 602 include five tiers. A first tier 602A of resources includes processing cores P0 and P1. A second tier 602B of resources includes processing cores P0-P3. A third tier 602C of resources includes processing cores P0-P7. A fourth tier 602D of resources includes processing cores P0-P9. A fifth tier 602E of resources includes processing cores P0-P11. The first subset of resources 506 is allocated based on the third tier 602C. In some embodiments, a higher tier 602D or 602E is selected to allocate more resources to implement the one or more queues 508 of I/O access operations, in a busy time. Conversely, in some embodiments, a lower tier 602A or 602B is selected to allocate less resources to implement the one or more queues 508 of I/O access operations, e.g., a downtime.

Stated another way, the host device 220 is made aware of certain tiers 602 of computational storage support on bootup. As an example, the storage device 240 lets the host device 220 know that the storage device can support 50% and 75% requirements of a certain performance metric (e.g., memory throughput, memory access bandwidth), while one or more other performance metrics are expected to change accordingly. In some embodiments, the one or more other performance metrics cannot change by the exact number as defined the one selected in a VU (Vendor Unique) command. In an example associated with a compute storage elevation (CSE) mode, an SSD lends its hardware resources (e.g., processing cores 504) to help with computational storage functions (e.g., internal data processing). Under some circumstances, information of the resource tiers 602 is confirmed by the host device 220 as part of a get_features command before the storage device 240 executes the CSE mode.

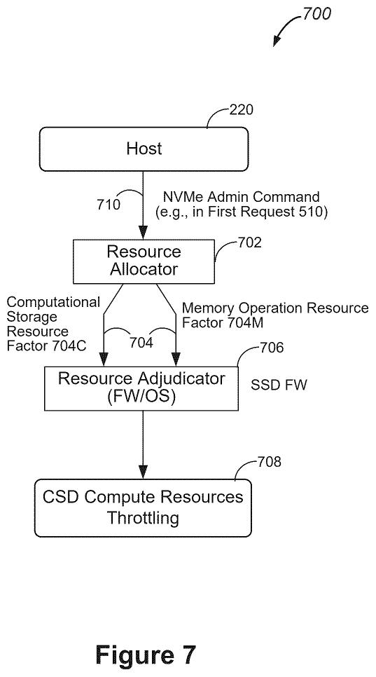

FIG. 7 is a flow diagram of a process 700 of enabling hardware resource throttling in a storage system 200 (e.g. a SSD memory system), in accordance with some embodiments. A first request 510 (e.g., including an admin command 710) is made by a host device 220, and identifies a target performance requirement 512 for processing the one or more queues 508 of I/O access operations. A firmware application of the storage system 200 includes a resource allocator 702. Upon receiving the first request, the resource allocator 702 determines that at least a target subset of resources 514 is needed for satisfy the target performance requirement 512. In some embodiments, the target subset of resources 514 corresponds to a change of allocated resources (e.g., a difference between two tiers 602C and 602B in FIG. 6) needed to satisfy the target performance requirement 512. In some embodiments, the resource allocator 702 measures a performance uniformity and other performance metrics that are included or not included in the first request 510 (e.g., in an admin command directive).

In some embodiments, the resource allocator 702 identifies an architecture of the device firmware application of the storage system 200, and determines whether a admin command configuration of the first request 510 received from the host device 220 is permissible in the storage system 200. In some situations, in accordance with a determination that the admin command configuration of the first request 510 is not permitted (e.g., that the target performance requirement cannot be satisfied), the storage device 240 sends an error signal (e.g., a message 518) to the host device 220 as a response to the first request 510.

In some embodiments, the storage device 240 includes a device stock keeping unit (SKU) setting forth whether an admin command configuration of the first request 510 is permissible in advance, which does not need to be dynamically determined in response to the first request 510. Further, in some embodiments, resource factor signals 704 are provided to an OS-level resource adjudicator 706 jointly with data processed by the resource allocator 702. Examples of the resource factor signals 704 include a computational storage resource factor 704C associated with computational storage functions implemented by a data processor 312 (FIG. 3), and a memory operation resource factor 704M associated with the storage controller 202. Additionally, in some embodiments, the resource adjudicator 706 adjusts OS-level resources that may need to change (e.g., a number of instances of an I/O access operation or a computational storage task, a task-affinity to cores). In some embodiments, the resource adjudicator 706 notifies a hardware abstraction layer (HAL) to ensure that the processing cores 504 are enabled or disabled for a corresponding type of OS resources. In some embodiments, the resource adjudicator 706 is configured to enable compute resources throttling 708 in response to a request received from the host device 220, e.g., suspending computational storage functions in the storage device 240 entirely and maximizing hardware resources allocated to implement the queue(s) 508 of I/O access operations for the host device 240.

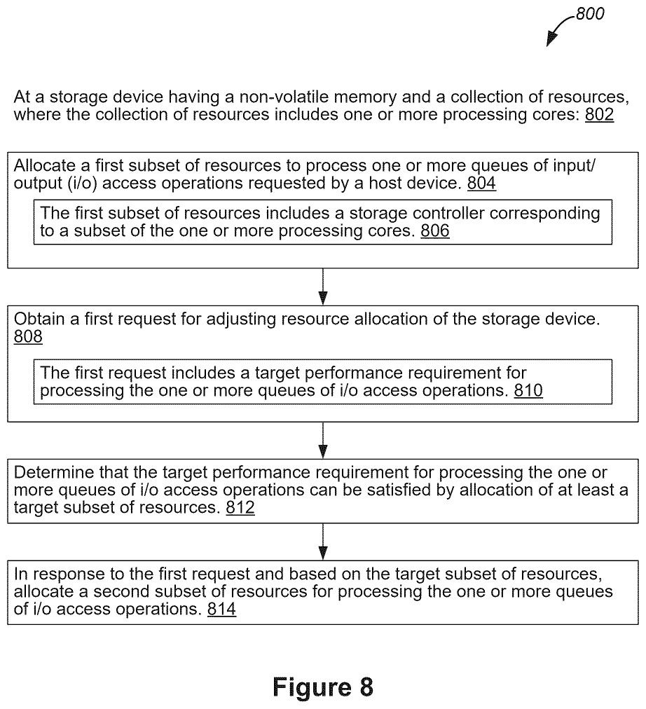

FIG. 8 is a flow diagram of an example method 800 for hardware resource allocation, in accordance with some embodiments. The method 800 is implemented at a storage device 240 or a storage system 200 to allocate hardware resources between memory access functions and computational storage functions. A storage device 240 has (operation 802) a non-volatile memory 306 and a collection of resources 502, and the collection of resources 502 includes one or more processing cores 504. The storage device 240 allocates (operation 804) a first subset of resources 506 (FIG. 5A) to process one or more queues 508 of input/output (I/O) access operations requested by a host device 220. The first subset of resources 506 includes (operation 806) a storage controller 202 corresponding to a subset of the one or more processing cores 504. The storage device 240 obtains (operation 808) a first request 510 for adjusting resource allocation of the storage device 240, and the first request 510 includes (operation 810) a target performance requirement 512 for processing the one or more queues 508 of I/O access operations. The storage device 240 determines (operation 812) that the target performance requirement 512 for processing the one or more queues 508 of I/O access operations can be satisfied by allocation of at least a target subset of resources 514. In response to the first request 510 and based on the target subset of resources 514, the storage device 240 allocates (operation 814) a second subset of resources 516 (FIG. 5B) for processing the one or more queues 508 of I/O access operations. In some embodiments, the storage device 240 receives the first request 510 from the host device 220 coupled to the storage device 240.

In some embodiments, the storage device 240 determines whether the storage device 240 has the target subset of resources 514 to be allocated to process the one or more queues 508 of I/O access operations, generates an acknowledge message 518 (FIG. 5B) indicating whether the target performance requirement 512 is satisfied based on a determination result, and in response to the first request, sending the acknowledge message 518 to the host device 220.

In some embodiments, in accordance with a determination that the storage device 240 does not have the target subset of resources 514 to be allocated to process the one or more queues 508 of I/O access operations, the storage device 240 implements one of (1) setting the second subset of resources 516 to a default subset of resources, independently of the target performance requirement 512 and (2) selecting the second subset of resources 516 to maximize a performance level of the storage device 240 for the one or more queues 508 of I/O access operations.

In some embodiments, wherein allocating the second subset of resources 516 further comprises, in accordance with a determination that the storage device 240 has the target subset of resources 514 to be allocated to process the one or more queues 508 of I/O access operations, setting the second subset of resources 516 to the target subset of resources 514.

In some embodiments, the target performance requirement 512 further includes a target value 522 of a first performance metric 524, and a target tolerance 526 of a second performance metric 528. The target subset of resources 514 is determined based on the target value 522 of the first performance metric 524 and the target tolerance 526 of the second performance metric 528. Further, in some embodiments, the storage device 240 identifies one or more predefined resource combinations corresponding to a plurality of resource tiers 602 (FIG. 6) to the storage device 240, and determines that one of the one or more predefined resource combinations corresponding to the second subset of resources 516 results in the first performance metric 524 meeting the target value 522 and the second performance metric 528 staying within the target tolerance 526, thereby reserving the second subset of resources 516.

In some embodiments, the first performance metric 524 includes a memory access bandwidth corresponding to a rate at which data are read from, or stored into, the non-volatile memory 306 by the one or more queues 508 of I/O access operations in response to host requests of a host device 220. The second performance metric 528 includes a memory throughput representing a number of input/output operations per second (IOPS) corresponding to the one or more queues 508 of I/O access operations implemented by the storage controller 202 in response to the host requests.

In some embodiments, the second performance metric 528 includes a memory access bandwidth corresponding to a rate at which data are read from, or stored into, the non-volatile memory 306 by the one or more queues 508 of I/O access operations in response to host requests of a host device 220, and the first performance metric 524 includes a memory throughput representing a number of IOPS corresponding to the one or more queues 508 of I/O access operations implemented by the storage controller 202 in response to the host requests.

In some embodiments, the target performance requirement 512 includes a target value 522 of a first performance metric 524, and the first subset of resources 506 corresponds to a current value of the first performance metric 524, and the target value 522 is lower than the current value.

In some embodiments, the first subset of resources 506 includes a first number of processing cores 504, and the second subset of resources 516 includes a second number of processing cores 504, and the first number is greater than the second number.

In some embodiments, based on the second subset of resources 516, the storage device 240 allocates a third subset of resources 534 (FIG. 5B) to implement a plurality of computational storage operations distinct from the one or more queues 508 of I/O access operations. Further, the first request 510 is received according to a schedule including a host downtime period and a host busy period, and the third subset of resources 534 includes a third number of processing cores 504. Whiling allocating the first subset of resources 506 to the one or more queues 508 of I/O access operations, the storage device 240 allocates a fourth number of processing cores 504 to implement the plurality of computational storage operations. The third number is greater than the fourth number during the host downtime period, and the third number is less than the fourth number during the host busy period. Additionally, in some embodiments, the first subset of resources 506 includes a first number of processing cores 504, and the second subset of resources 516 includes a second number of processing cores 504. The first number of processing cores 504 and the fourth number of processing cores 504 are complementary to each other in the one or more processing cores 504. The second number of processing cores 504 and the third number of processing cores 504 are complementary to each other in the one or more processing cores 504.

Additionally, in some embodiments, the third subset of resources 534 includes a subset of the one or more processing cores 504 that are unused before the first request 510 was obtained, and the first request 510 includes a request for a burst of workloads including the plurality of computational storage operations. In some embodiments, each of the plurality of computational storage operations includes a data processing operation performed internally in the storage device 240 to process data stored or to be stored in the non-volatile memory 306. In some embodiments, the first subset of resources 506 includes a first processing core configured to execute a device I/O task. The storage device 240 allocates the third subset of resources 534 by reassigning, on an operating system abstraction level, the first processing core to execute a subset of the plurality of computational storage operations. In some embodiments, the third subset of resources 534 is allocated in accordance with a determination that a computational storage enhancement (CSE) mode is activated in the storage device 240.

In some embodiments, the first subset of resources 506 of the storage device 240 is adjusted based on a plurality of performance metrics, and the target performance requirement 512 includes at least one of the plurality of performance metrics. Each of the plurality of performance metrics is one of: a memory throughput, a memory access bandwidth, and a quality of service, and is greater than a respective metric threshold when the second subset of resources 516 is applied to implement the one or more queues 508 of I/O access operations.

In some embodiments, the first subset of resources 506 is allocated during a system bootup stage. During the system bootup stage, the storage device 240 provides, to a host device 220, information a plurality of resource tiers 602, and receives a selection of an initial resource tier from the plurality of resource tiers 602. The first subset of resources 506 is allocated based on the selection of the initial resource tier.

In some embodiments, the storage device 240 allocates the first subset of resources 506 by, during a system bootup stage, varying a size of the storage controller 202 to prioritize a first set of performance metrics over a second set of performance metrics and adjust each of the first set of performance metrics into a respective metric range.

In some embodiments, each of the one or more queues 508 of I/O access operations includes a subset of: host-request memory read, host-requested memory write, garbage collection, wear levelling, read disturb mitigation, memory snapshot capturing, memory mirroring, caching, and memory sparing.

In some embodiments, the collection of resources 502 further includes a subset of: volatile memory, operating system instances, and affinity to cores.

In some embodiments, the storage device 240 disables the first subset of resources 506, independently of the target subset of resources 514, before allocating the second subset of resources 516 for processing the one or more queues 508 of I/O access operations.

In some embodiments, the first subset of resources 506 of the storage device 240 is adjusted in response to the first request 510 without restarting or reconfiguring the storage device 240.

Memory is also used to store instructions and data associated with the method 800, and includes high-speed random access memory, such as DRAM, SRAM, DDR RAM, or other random access solid state storage devices; and, optionally, includes non-volatile memory, such as one or more magnetic disk storage devices, one or more optical disk storage devices, one or more flash storage devices, or one or more other non-volatile solid state storage devices. The memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores the programs, modules, and data structures, or a subset or superset for implementing method 800.

Each of the above identified elements may be stored in one or more of the previously mentioned storage devices, and corresponds to a set of instructions for performing a function described above. The above identified modules or programs (i.e., sets of instructions) need not be implemented as separate software programs, procedures, modules or data structures, and thus various subsets of these modules may be combined or otherwise rearranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. A method for hardware resource allocation, comprising:
at a storage device having a non-volatile memory and a collection of resources, wherein the collection of resources includes one or more processing cores:
allocating a first subset of resources to process one or more queues of input/output (I/O) access operations requested by a host device, wherein the first subset of resources includes a storage controller corresponding to a subset of the one or more processing cores;
obtaining a first request for adjusting resource allocation of the storage device, the first request including a target performance requirement for processing the one or more queues of I/O access operations;
determining that the target performance requirement for processing the one or more queues of I/O access operations can be satisfied by allocation of at least a target subset of resources; and
in response to the first request and based on the target subset of resources, allocating a second subset of resources for processing the one or more queues of I/O access operations.

2. The method of claim 1, wherein the storage device receives the first request from the host device coupled to the storage device.

3. The method of claim 1, further comprising:
determining whether the storage device has the target subset of resources to be allocated to process the one or more queues of I/O access operations;
generating an acknowledge message indicating whether the target performance requirement is satisfied based on a determination result; and
in response to the first request, sending the acknowledge message to the host device.

4. The method of claim 1, further comprising, in accordance with a determination that the storage device does not have the target subset of resources to be allocated to process the one or more queues of I/O access operations, implementing one of:
setting the second subset of resources to a default subset of resources, independently of the target performance requirement; and
selecting the second subset of resources to maximize a performance level of the storage device for the one or more queues of I/O access operations.

5. The method of claim 1, wherein allocating the second subset of resources further comprises, in accordance with a determination that the storage device has the target subset of resources to be allocated to process the one or more queues of I/O access operations, setting the second subset of resources to the target subset of resources.

6. The method of claim 1, wherein:
the target performance requirement further includes a target value of a first performance metric, and a target tolerance of a second performance metric; and
the target subset of resources is determined based on the target value of the first performance metric and the target tolerance of the second performance metric.

7. The method of claim 6, allocating a second subset of resources further comprising:
identifying one or more predefined resource combinations corresponding to a plurality of resource tiers to the storage device; and
determining that one of the one or more predefined resource combinations corresponding to the second subset of resources results in the first performance metric meeting the target value and the second performance metric staying within the target tolerance, thereby reserving the second subset of resources.

8. The method of claim 6, wherein:
the first performance metric includes a memory access bandwidth corresponding to a rate at which data are read from, or stored into, the non-volatile memory by the one or more queues of I/O access operations in response to host requests of a host device, and the second performance metric includes a memory throughput representing a number of input/output operations per second (IOPS) corresponding to the one or more queues of I/O access operations implemented by the storage controller in response to the host requests; and
the second performance metric includes a memory access bandwidth corresponding to a rate at which data are read from, or stored into, the non-volatile memory by the one or more queues of I/O access operations in response to host requests of a host device, and the first performance metric includes a memory throughput representing a number of IOPS corresponding to the one or more queues of I/O access operations implemented by the storage controller in response to the host requests.

9. The method of claim 1, wherein the target performance requirement includes a target value of a first performance metric, and the first subset of resources corresponds to a current value of the first performance metric, and the target value is lower than the current value.

10. The method of claim 1, wherein the first subset of resources includes a first number of processing cores, and the second subset of resources includes a second number of processing cores, and the first number is greater than the second number.

11. The method of claim 1, further comprising:
based on the second subset of resources, allocating a third subset of resources to implement a plurality of computational storage operations distinct from the one or more queues of I/O access operations.

12. The method of claim 11, wherein the first request is received according to a schedule including a host downtime period and a host busy period, and the third subset of resources includes a third number of processing cores, the method further comprising:
whiling allocating the first subset of resources to the one or more queues of I/O access operations, allocating a fourth number of processing cores to implement the plurality of computational storage operations;
wherein the third number is greater than the fourth number during the host downtime period, and the third number is less than the fourth number during the host busy period.

13. The method of claim 11, wherein the third subset of resources includes a subset of the one or more processing cores that are unused before the first request was obtained, and the first request includes a request for a burst of workloads including the plurality of computational storage operations.

14. The method of claim 11, wherein each of the plurality of computational storage operations includes a data processing operation performed internally in the storage device to process data stored or to be stored in the non-volatile memory.

15. The method of claim 11, wherein the third subset of resources is allocated in accordance with a determination that a computational storage enhancement (CSE) mode is activated in the storage device.

16. The method of claim 1, wherein:
the first subset of resources of the storage device is adjusted based on a plurality of performance metrics, and the target performance requirement includes at least one of the plurality of performance metrics; and
each of the plurality of performance metrics is one of: a memory throughput, a memory access bandwidth, and a quality of service and is greater than a respective metric threshold when the second subset of resources is applied to implement the one or more queues of I/O access operations.

17. The method of claim 1, wherein the first subset of resources is allocated during a system bootup stage, the method further comprising, during the system bootup stage:
providing, to a host device, information a plurality of resource tiers; and
receiving a selection of an initial resource tier from the plurality of resource tiers, the first subset of resources being allocated based on the selection of the initial resource tier.

18. The method of claim 1, wherein allocating the first subset of resources further comprises, during a system bootup stage:
varying a size of the storage controller to prioritize a first set of performance metrics over a second set of performance metrics and adjust each of the first set of performance metrics into a respective metric range.

19. A storage device, comprising:
a collection of resources including one or more processing cores;
a non-volatile memory coupled to the storage controller; and
memory having instructions stored thereon for:
allocating a first subset of resources to process one or more queues of input/output (I/O) access operations requested by a host device, wherein the first subset of resources includes a storage controller corresponding to a subset of the one or more processing cores;
obtaining a first request for adjusting resource allocation of the storage device, the first request including a target performance requirement for processing the one or more queues of I/O access operations;
determining that the target performance requirement for processing the one or more queues of I/O access operations can be satisfied by allocation of at least a target subset of resources; and
in response to the first request and based on the target subset of resources, allocating a second subset of resources for processing the one or more queues of I/O access operations.

20. A non-transitory computer-readable storage medium, having instructions stored thereon, which when executed by a storage device cause the storage device to implement operations comprising:
at the storage device, wherein the storage device includes a non-volatile memory and a collection of resources, and the collection of resources includes one or more processing cores:
allocating a first subset of resources to process one or more queues of input/output (I/O) access operations requested by a host device, wherein the first subset of resources includes a storage controller corresponding to a subset of the one or more processing cores;
obtaining a first request for adjusting resource allocation of the storage device, the first request including a target performance requirement for processing the one or more queues of I/O access operations;
determining that the target performance requirement for processing the one or more queues of I/O access operations can be satisfied by allocation of at least a target subset of resources; and
in response to the first request and based on the target subset of resources, allocating a second subset of resources for processing the one or more queues of I/O access operations.
